(19) United States
(12) Patent Application Publication
(10) Pub. No.: US 2025/0238038 A1
(43) Pub. Date: Jul. 24, 2025

(54) AUTONOMOUS DRIVING DEVICE FOR PROVIDING VISUALIZED VIRTUAL GUIDE INFORMATION, AND OPERATING METHOD THEREFOR

(71) Applicant: INTEGRIT INC., Seoul (KR)

(72) Inventor: Han Hee CHO, Seoul (KR)

(73) Assignee: INTEGRIT INC., Seoul (KR)

(21) Appl. No.: 18/703,323

(22) PCT Filed: Sep. 26, 2022
(86) PCT No.: PCT/KR2022/014341

§ 371 Date: Apr. 19, 2024

(30) Foreign Application Priority Data
Oct. 22, 2021 (KR) 10-2021-0141674

(51) Int. Cl. G05D 1/656; G06T 7/246; G10L 15/02; G10L 15/22

(52) U.S. Cl. CPC G05D 1/656; G06T 7/246; G10L 15/02; G10L 15/22; G06T 2207/30196; G06T 2207/30261; G10L 2015/225

(57) ABSTRACT

An autonomous driving device for providing visualized virtual guide information, according to one embodiment of the present invention, includes: an input unit for recognizing and inputting a voice and a motion of an object; a voice analysis unit for analyzing a voice feature value of the object; an image analysis unit for analyzing a motion feature value of the object; a determination unit for defining the meanings of the feature value of the voice and the feature value of the motion, and then determining feedback information corresponding to the defined meanings; and a virtualization unit for outputting guide information about the feedback information by generating or receiving visual information based on augmented reality or virtual reality.

### TECHNICAL FIELD

The present invention relates to an autonomous driving device for providing visualized virtual guide information and an operating method thereof.

### BACKGROUND ART

Recently, there have been many developments in robots that are used in people's lives, such as office robots and pet robots, unlike conventional industrial robots. These robots are intended to guide people to their destinations in offices, talk with elderly people as conversation partners, and more. For example, as an office robot, a robot was developed to ask a visitor about his or her destination and upon hearing the destination, guide the visitor to the destination by moving toward the destination by the visitor walking with the robot.

Large-scale department stores, outdoor exhibitions, and other places have complex structures and large areas of movement. Accordingly, for the convenience of users, information centers are set up at specific locations and staffed with guides or kiosks are installed to provide guidance services to users. In such a guidance method according to the conventional art, a guidance service is provided at a specific location, and thus a user should go to an information center where a guide is present or a kiosk is installed to receive the guidance service. In other words, for first-time visitors, finding an information center or kiosk is the first barrier to using the guidance spot. That is, the guidance method according to the conventional art has the problem of not providing an active guidance service to users.

This problem causes significant time to be spent on guiding users, which may result in wasted labor costs, inefficient waste of working hours, and a problem of reducing the mobility of users.

Korean Patent No. 10-1012288 relates to a moving guidance robot that autonomously moves in a specific place to interact with users and provide a location information service, a local information service, a local advertisement service, a mobile coupon issuance service, a ticket sales service, and the like to the users, and a system thereof. The patent discloses a moving guidance robot that includes a location information receiving unit, a drive unit, a sensor unit, an input unit, a storage unit (database (DB)), a communication unit, a central control unit, an output unit, and a mobile coupon issuance unit, and when a user is issued a mobile coupon, the central control unit transmits mobile coupon issuance information to a central management server for managing a guidance place, a personal terminal of a store, and a mobile communication terminal of the user issued the mobile coupon.

Korean Patent Application No. 10-2013-0024159 discloses an apparatus and method for detecting a distance which make it possible to detect not only the distance to an obstacle (a measurement surface) present in the front, back, left, or right direction but also the distance to an obstacle (a measurement surface) present in the up or down direction by rotating a distance detection sensor installed in the body of a robot, which includes a guidance unit including a distance detection sensor and a drive unit, and also reciprocating (raising and lowering) the distance detection sensor in the up and down directions.

Japanese Patent Publication No. 8-108381 relates to a mobile robot that can accurately travel along a passage set by a guiderail and has a high degree of following to have no difficulty passing through a curved passage and prevent itself from falling. The mobile robot has a vehicle frame of which front and rear portions are supported by a bogie car to perform rotary motion, and a guiderail for defining the trajectory of the vehicle frame. The bogie car includes one pair of left and right traveling wheels supported by an axle orthogonal to a pivot and guide rollers. The guide rollers include one magnetic roller electrically moving along one side of the guiderail and two pressure rollers arranged to electrically move along the other side, and the two pressure rollers are arranged symmetrically to the left and right with respect to the vertical plane in which the contact of a ruler roller and the guiderail is connected to the pivot. Specifically, it discloses a configuration in which rollers installed in front of and behind the body frame are disposed on opposite sides of the guiderail.

Japanese Patent Publication No. 2004-216552 relates to a mobile robot that identifies its location by flashing landmarks installed in a workspace and autonomously moves, and an autonomous movement system and method thereof. The patent discloses a configuration including a communication module which outputs a light source control signal for selectively flashing landmarks installed in a workspace, an image processing module which detects a light source flashing on the basis of the light source control signal from an image signal acquired by a camera and reads image coordinates of the light source,
a location calculation module which calculates location coordinates of a mobile robot using the read image coordinates and previously memorized global coordinates of the workspace, a motion control module which sets a movement path to a destination by matching the calculated location coordinates of the mobile robot to previously memorized spatial coordinates of the workspace and drives the mobile robot, and a main control module which controls operations of the modules and overall operations of the mobile robot.

### DISCLOSURE

### Technical Problem

The present invention is directed to providing an autonomous driving device for providing visualized virtual guide information and an operating method thereof with which the conventional problems can be solved.

### Technical Solution

One aspect of the present invention provides an autonomous driving device for providing visualized virtual guide information, the autonomous driving device including: an input unit configured to recognize and receive a voice and motion of an object, a voice analysis unit configured to analyze a voice feature value of the object, an image analysis unit configured to analyze a motion feature value of the object, a determination unit configured to define a meaning of the feature value of the voice and the feature value of the motion and then determine feedback information corresponding to the defined meaning, and a virtualization unit configured to generate or receive visual information based on augmented reality or virtual reality and output guide information for the feedback information.

The autonomous driving device may further include an autonomous driving unit configured to travel in a preset zone or place on the basis of autonomous driving information set by an external terminal.

The autonomous driving unit may move to a location of the object when a specific sound or specific motion of the object is detected.

The autonomous driving device may further include a sensor unit including a location sensor for transmitting or receiving one or more of a Wi-Fi signal, a wireless display (WiDi) signal, an ultra-wideband (UWB) signal, a Bluetooth signal, an infrared signal, an ultraviolet signal, an ultrasonic signal, a Global Positioning System (GPS) signal, and a wireless signal which performs a similar function thereto, and a motion sensor (a motion measurement sensor) for measuring inertia (an angular velocity and an acceleration), altitude, and the like according to movement of the object or measuring other object movement, and the motion sensor may directly measure the altitude, measure an atmospheric pressure, or measure movement of the object using an angle, a velocity, the acceleration, the angular velocity, and the like.

The autonomous driving device may receive the guide information for the feedback information from an external server using the visual information based on augmented reality or virtual reality and update and learn the guide information.

Another aspect of the present invention provides an operating method of an autonomous driving device for providing visualized virtual guide information, the operating method including: receiving a voice and image (motion) of an object, analyzing feature values of the voice and image (motion) of the object, defining a meaning of the feature value of the voice and the feature value of the image (motion) and then determining feedback information corresponding to the defined meaning, and outputting guide information for the determined feedback information using visual information based on augmented reality or virtual reality.

### Advantageous Effects

When an autonomous driving device for providing visualized virtual guide information according to an embodiment of the present invention is used, it is possible to provide visual information in which guide information about geographic locations, information inquiries of offline customers, and the like is applied to virtual content.

### DESCRIPTION OF DRAWINGS

FIG. 1 is a network configuration diagram of an autonomous driving device for providing visualized virtual guide information according to an embodiment of the present invention.

FIG. 2 is a detailed configuration diagram of the autonomous driving device shown in FIG. 1.

FIG. 3 is a flowchart illustrating an operating method of the autonomous driving device shown in FIG. 1.

FIG. 4 is a diagram of an illustrative computing environment in which one or more embodiments disclosed in this specification can be implemented.

### BEST MODE OF THE INVENTION

Hereinafter, embodiments of the present invention will be described in detail with reference to the accompanying drawings so that those skilled in the technical field to which the present invention pertains can easily implement the present invention. However, the present invention can be implemented in many different forms and is not limited to the embodiments described herein. To clearly describe the present invention, parts irrelevant to the description will be omitted in the drawings, and throughout the specification, like reference numerals refer to like parts.

Throughout the specification, when a first part is referred to as being “connected” to a second part, the first part may be “directly connected” to the second part, or the first part may be “electrically connected” to the second part with a third element therebetween. Also, when a part is referred to as “including” a component, other components are not excluded, and the part may further include other components unless specifically stated otherwise. This should be understood as not precluding the presence or addition of one or more other features, integers, steps, operations, components, parts, or combinations thereof.

Throughout the specification, terms representing a degree, such as “about,” “substantially,” and the like, are used to indicate a value which is, when a unique manufacturing tolerance or material tolerance is given in the description, approximately equal to the numerical value and also to prevent an unscrupulous infringer from unjustly using the description in which an accurate or absolute numerical value is presented to help understanding of the present invention. As used in the specification, the term representing “step of” does not mean “step for.”

As used herein, the term “unit” includes a unit implemented by hardware, a unit implemented by software, and a unit implemented by both. Also, one unit may be implemented using two or more pieces of hardware, and two or more units may be implemented by one piece of hardware.

In this specification, some operations or functions described as being performed by a terminal, an apparatus, or a device may be performed instead by a server connected to the terminal, the apparatus, or the device. Similarly, some operations or functions described as being performed by the server may also be performed by the terminal, the apparatus, or the device connected to the server.

In this specification, some operations or functions of mapping or matching a terminal may be construed as mapping or matching the unique number of the terminal or the identification information of an individual.

An autonomous driving device for providing visualized virtual guide information and an operating method thereof according to embodiments of the present invention will be described in detail below with reference to the accompanying drawings.

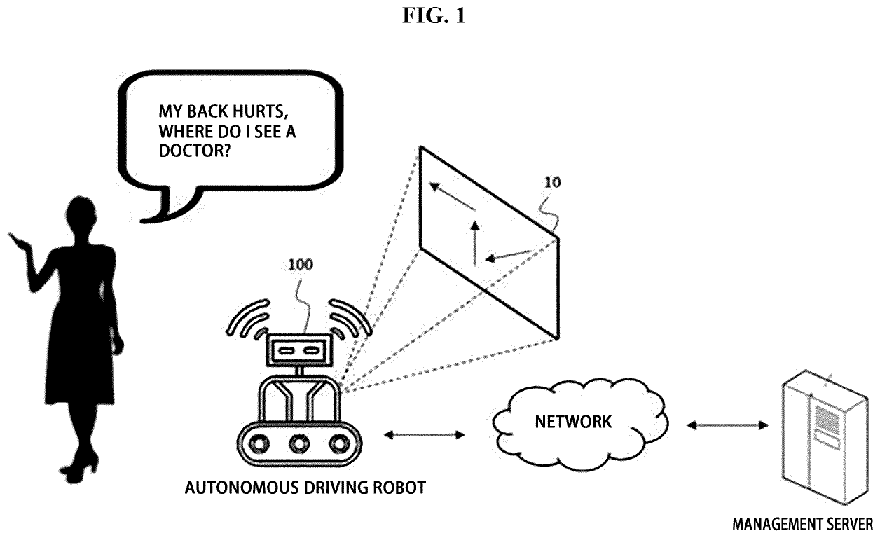

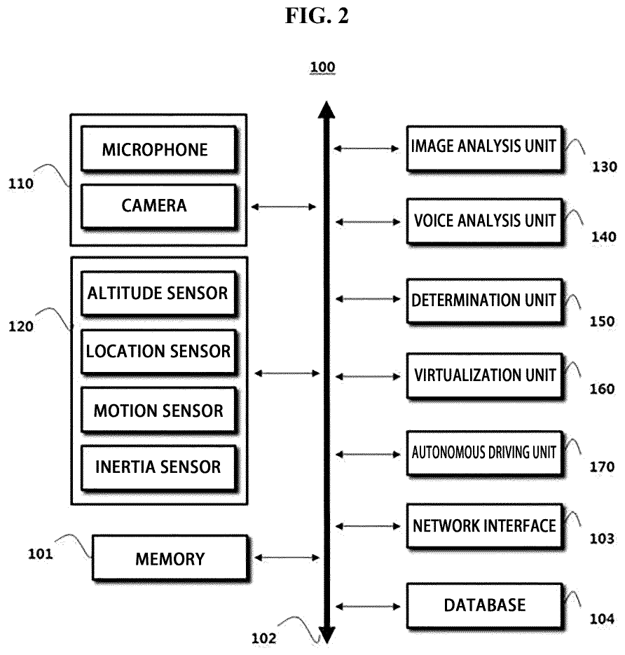

FIG. 1 is a network configuration diagram of an autonomous driving device for providing visualized virtual guide information according to an embodiment of the present invention, and FIG. 2 is a detailed configuration diagram of the autonomous driving device shown in FIG. 1.

As described in FIGS. 1 and 2, an autonomous driving device 100 for providing visualized virtual guide information according to an embodiment of the present invention includes an input unit 110, an image analysis unit 130, a voice analysis unit 140, a determination unit 150, and a virtualization unit 160.

Meanwhile, the autonomous driving device 100 may further include an autonomous driving unit 180 for traveling in a preset zone or place on the basis of autonomous driving information set by an external terminal, and the autonomous driving unit 180 may be designed to move to the location of an object when a specific sound and a specific motion of the object are detected by the input unit which will be described below.

Also, the autonomous driving device 100 of the present invention may be connected to an external terminal, an external server, or a display through a network. The external terminal may be applied to various terminals such as a smartphone, a portable terminal, a mobile terminal, a foldable terminal, a personal digital assistant (PDA), a portable multimedia player (PMP) terminal, a telematics terminal, a navigation terminal, a personal computer (PC), a laptop computer, a slate PC, a tablet PC, an Ultrabook, a wearable device (e.g., a smartwatch, smart glasses, a head mounted display (HMD), or the like), a wireless broadband (WiBro) terminal, an Internet protocol television (IPTV), a smart TV, a digital broadcast terminal, an audio video navigation (AVN) terminal, an audio/video (A/V) system, a flexible terminal, a digital signage device, and the like.

The network is a wireless local area network (WLAN), a Digital Living Network Alliance (DLNA) network, a WiBro network, a World Interoperability for Microwave Access (WiMAX) network, a high speed downlink packet access (HSDPA) network, a high speed uplink packet access (HSUPA) network, an Institute of Electrical and Electronics Engineers (IEEE) 802.16 network, a Long Term Evolution (LTE) network, an LTE-Advance (LTE-A) network, a fifth generation (5G) (international mobile telecommunication (IMT)-2020) network, a wireless mobile broadband service (WMBS) network, or the like, and a communication unit transmits and receives data according to at least one of wireless Internet technologies even including those not listed above. Also, short-range communication technology may include Bluetooth, radio frequency identification (RFID), infrared data association (IrDA), ultra-wideband (UWB), ZigBee, near field communication (NFC), ultra-sound communication (USC), visible light communication (VLC), Wi-Fi, Wi-Fi direct, and the like. In addition, wired communication technology may include power line communication (PLC), Universal Serial Bus (USB) communication, Ethernet, serial communication, an optical/coaxial cable, and the like.

First, the input unit 110 is an element for receiving at least one of a voice, a motion, and an image of an object (person) and may include a microphone and a three-dimensional (3D) camera (a light detection and ranging (LiDAR), a short-range time-of-flight (ToF) camera, or the like supporting a high resolution and a wide angle).

The voice analysis unit 140 converts the voice of the object (person) into text, parses the text into one or more units of text according to a preset criterion, and then filters out text with a preset number of syllables or less among the units of text.

For reference, the voice analysis unit 140 can parse the entire text into one or more units of text in various ways other than the foregoing parsing procedure, and thus the present invention is not limited to the method described above.

The voice analysis unit 140 outputs words, phrases, clauses, and the like in the filtered text using feature values.

Subsequently, the image analysis unit 130 analyzes a feature value of a motion (image) of the object.

More specifically, the image analysis unit 130 extracts a user image on the basis of feature points of the user's body in an object image and then analyzes the feature value of the motion of the object by comparing shape information of the extracted user image with learned training shape information.

For reference, the image analysis unit 130 may perform one or more preprocessing operations among binarization, sessionization, and noise reduction on the object image. Also, the object image may be modified or improved using a Gaussian filter, a Laplacian filter, a difference of Gaussian (DoG), canny edge detection, and the like.

As an example, the image analysis unit 130 may reduce noise using a Gaussian filter and the like and perform a gradient operation for detecting edge elements, non-maximum suppression for interpolating disconnected edge lines, and hysteresis thresholding for binarizing an edge map.

Meanwhile, the image analysis unit 130 normalizes and clusters or classifies a user body image (shape) extracted on the basis of the feature points of the object's body in the object image and then analyzes an object shape (feature value) by comparing several pieces of object shape information which are learned using a deep neural network algorithm.

For reference, clustering processes are classified as partitioning methods and hierarchical methods. According to clustering with partitioning methods, a dataset is partitioned into small groups with the rule that each group has at least one piece of data and each piece of data belongs to exactly one group. Such clustering with partitioning methods includes a K-means technique, a K-medoids technique, a density based spatial clustering of applications with noise (DBCAN) technique, and the like.

According to hierarchical methods, a dataset is hierarchically partitioned. The hierarchical methods are classified again into agglomerative clustering and divisive clustering.

Subsequently, the determination unit 150 defines the meaning of the feature value of the voice and the feature value of the motion and then determines feedback information corresponding to the defined meaning.

For example, the determination unit 150 may analyze the user's movement pattern on the basis of angular velocity information, acceleration information, or altitude information resulting from the object's movement or other information for determining the user's movement and define the user's situation, posture, or the like according to the movement pattern.

Also, the determination unit 150 may calculate and evaluate motion (posture) information of the subject according to preset posture classification criteria using a gravity line B and a centerline D and define the motion.

Further, the determination unit 150 learns the user's posture, movement, or situation on the basis of the calculated posture information resulting from the user's movement and sets a reference value for a definition value on the basis of a learned result pattern.

Here, the determination unit 150 may employ a deep learning algorithm, which may be a deep belief network, an autoencoder, a convolutional neural network (CNN), a recurrent neural network (RNN), a deep Q-network, or the like. The deep learning algorithms listed in the present invention are only illustrative, and that employed by the determination unit 150 is not limited thereto. In addition to a deep learning algorithm, a machine learning algorithm, such as a support vector machine (SVM), K-means square, or the like for defining shape information, may be employed instead of a deep learning algorithm, and a dynamic variation formula for calculating a variation per unit time may also be employed.

Subsequently, the virtualization unit 160 generates or receives visual information based on augmented reality or virtual reality and outputs guide information for the feedback information.

The virtualization unit 160 may further include an icon having a speech bubble shape in the visual information, and the icon may provide an image or pictogram of the target object or the target location, graphics information about a directional line and the like in the speech bubble shape.

Meanwhile, the autonomous driving device 100 according to an embodiment of the present invention may further include a sensor unit 120 for transmitting or receiving one or more of a Wi-Fi signal, a WiDi signal, a UWB signal, a Bluetooth signal, an infrared signal, an ultraviolet signal, an ultrasonic signal, a GPS signal, and a wireless signal which performs a similar function thereto, and a motion sensor (motion measurement sensor) for measuring inertia (an angular velocity and an acceleration), altitude, and the like according to the object's movement or measuring other object movement.

The motion sensor may directly measure the altitude, measure an atmospheric pressure, or measure the object's movement using an angle, a velocity, the acceleration, the angular velocity, and the like.

The autonomous driving device 100 may receive the guide information for the feedback information from the external server using the visual information based on augmented reality or virtual reality and update the guide information.

Meanwhile, the autonomous driving device 100 according to an embodiment of the present invention may include a memory 101, a bus 102, a network interface 103, and a database (DB) 104.

The memory 101 is a computer-readable recording medium and may include a permanent mass storage device such as a random access memory (RAM), a read-only memory (ROM), and a disk drive. In the memory 101, an operating system (OS) and program code for a service provision routine may be stored.

Such software components may be loaded from a computer-readable recording medium which is separate from the memory 240, using a drive mechanism (not shown). The separate computer-readable recording medium may be a computer-readable recording medium (not shown) such as a floppy drive, a floppy disk, tape, a digital versatile disc (DVD)/compact disc (CD)-ROM drive, a memory card, and the like. In other embodiments, software components may be loaded to a memory through a network interface rather than a computer-readable recording medium.

The bus 102 may allow communication and data transmission between components.

The bus 102 may be a high-speed serial bus, a parallel bus, a storage area network (SAN), and/or a bus based on other appropriate communication technology.

The network interface 103 may be a computer hardware component for connecting the autonomous driving device 100 to a computer network. The network interface 103 may be a network interface card, such as an Ethernet card, an optical transceiver, an RF transceiver, or any other type of device for transmitting and receiving information.

Other examples of the network interface may be USB interfaces in mobile computing devices and wireless devices based on Bluetooth, third generation (3G), Wi-Fi, and the like.

In some examples, a computing device may employ a network interface to wirelessly communicate with an external device such as a server, a mobile phone, or another networked computing device. The network interface may connect the corresponding device to a computer network through a wireless or wired connection.

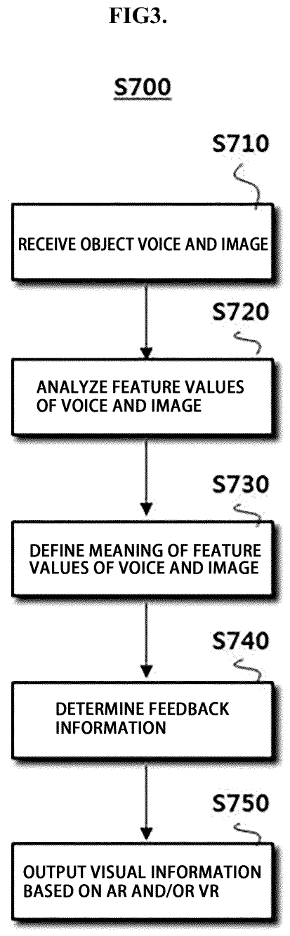

FIG. 3 is a flowchart illustrating an operating method of an autonomous driving device for providing a visualized virtual interface according to an embodiment of the present invention.

Referring to FIG. 3, in an operating method S700 of an autonomous driving device for providing a visualized virtual interface according to an embodiment of the present invention, a voice and image (motion) of an object are detected and input first (S710). Subsequently, feature values of the voice and image (motion) are analyzed (S720), the meaning of the feature value of the voice and the feature value of the image (motion) is defined (S730), and then feedback information corresponding to the defined meaning is determined (S740). Subsequently, guide information for the determined feedback information is output using visual information based on augmented reality or virtual reality (S750).

Operation S730 may include a process of analyzing the user's movement pattern on the basis of angular velocity information, acceleration information, or altitude information resulting from the object's movement or other information for determining the user's movement and defining the user's situation, posture, or the like according to the movement pattern.

Also, operation S730 may include a process of calculating and evaluating motion (posture) information of the subject according to preset posture classification criteria using a gravity line B and a centerline D and defining the motion.

Further, operation S730 may include a process of learning the user's posture, movement, or situation on the basis of the calculated motion information resulting from the user's movement and setting a reference value for a definition value on the basis of a learned result pattern.

When an autonomous driving device for providing visualized virtual guide information according to an embodiment of the present invention is used, it is possible to provide visual information in which guide information about geographic locations, information inquiries of offline customers, and the like is applied to virtual content.

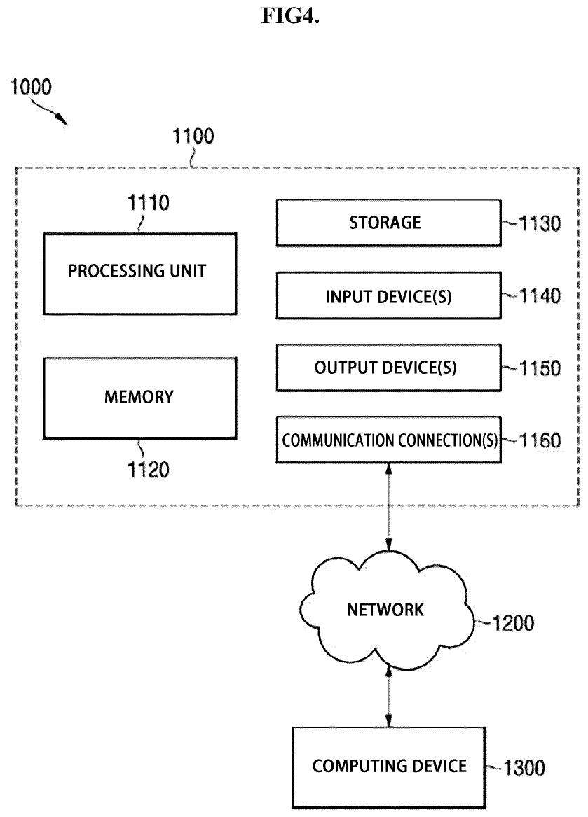

FIG. 4 is a diagram of an illustrative computing environment in which one or more embodiments disclosed in this specification can be implemented, showing an example of a system 1000 including a computing device 1100 configured to implement the one or more embodiments described above. For example, the computing device 1100 is, but is not limited to, a PC, a server computer, a handheld or laptop device, a mobile device (a mobile phone, a PDA, a media player, or the like), a multiprocessor system, a consumer electronic device, a mini computer, a mainframe computer, a distributed computing environment including any of the foregoing systems or devices, or the like.

The computing device 1100 may include at least one processing unit 1110 and a memory 1120. The processing unit 1110 may include, for example, a central processing unit (CPU), a graphics processing unit (GPU), a microprocessor, an application-specific integrated circuit (ASIC), a field programmable gate array (FPGA), and the like and have a plurality of cores. The memory 1120 may be a volatile memory (e.g., a RAM or the like), a non-volatile memory (e.g., a ROM, a flash memory, or the like), or a combination thereof. The computing device 1100 may include an additional storage 1130. The storage 1130 includes, but is not limited to, a magnetic storage, an optical storage, or the like. In the storage 1130, computer-readable instructions for implementing the one or more embodiments disclosed herein may be stored, and other computer-readable instructions for implementing the OS, application programs, and the like may also be stored. The computer-readable instructions stored in the storage 1130 may be loaded to the memory 1120 in order to be executed by the processing unit 1110. Also, the computing device 1100 may include an input device(s) 1140 and an output device(s) 1150.

Here, the input device(s) 1140 may include, for example, a keyboard, a mouse, a pen, a voice input device, a touch input device, an infrared camera, a video input device, any other input device, or the like. Also, the output device(s) 1150 may include, for example, one or more displays, a speaker, a printer, any other output device, or the like. Further, the computing device 1100 may employ an input device or an output device provided in another computing device as the input device(s) 1140 or the output device(s) 1150.

In addition, the computing device 1100 may include a communication connection(s) 1160 that allows the computing device 1100 to communicate with another device (e.g., a computing device 1300).

The communication connection(s) 1160 may include a modem, a network interface card (NIC), an integrated network interface, an RF transmitter/receiver, an infrared port, a USB connection, or another interface for connecting the computing device 1100 to another computing device. Also, the communication connection(s) 1160 may include a wired connection or a wireless connection. The foregoing components of the computing device 1100 may be connected through various interconnections (e.g., peripheral component interconnect (PCI), USB, firmware (IEEE 1394), an optical bus structure, and the like), such as a bus and the like, or may be interconnected through a network 1200. As used herein, the terms “component,” “system,” and the like generally indicate hardware, a combination of hardware and software, software, or a computer-related entity which is running.

For example, a component may be, but is not limited to, a process, a processor, an object, an executable, an executed thread, a program, and/or a computer. As an example, both an application running on a controller and the controller may be components. One or more components may exist in a process and/or an executed thread, and a component may be localized on one computer or distributed over two or more computers.

Although the present invention has been described in detail above with reference to embodiments, it will be apparent to those of ordinary skill in the art to which the present invention pertains that various substitutions, additions, and modifications can be made without departing from the technical spirit described above. It is to be understood that such modified embodiments also fall within the scope of the present invention defined by the following claims.

1. An autonomous driving device for providing visualized virtual guide information, the autonomous driving device comprising:
an input unit configured to recognize and receive a voice and motion of an object;
a voice analysis unit configured to analyze a voice feature value of the object;
an image analysis unit configured to analyze a motion feature value of the object;
a determination unit configured to define a meaning of the feature value of the voice and the feature value of the motion and then determine feedback information corresponding to the defined meaning; and
a virtualization unit configured to generate or receive visual information based on augmented reality or virtual reality and output guide information for the feedback information.

2. The autonomous driving device of claim 1, further comprising an autonomous driving unit configured to travel in a preset zone or place on the basis of autonomous driving information set by an external terminal.

3. The autonomous driving device of claim 1, wherein the autonomous driving unit moves to a location of the object when a specific sound or specific motion of the object is detected.

4. The autonomous driving device of claim 1, further comprising a sensor unit including a location sensor for transmitting or receiving one or more of a Wi-Fi signal, a wireless display (WiDi) signal, an ultra-wideband (UWB) signal, a Bluetooth signal, an infrared signal, an ultraviolet signal, an ultrasonic signal, a Global Positioning system (GPS) signal, and a wireless signal which performs a similar function thereto, and a motion sensor (a motion measurement sensor) for measuring inertia (an angular velocity and an acceleration), altitude, and the like according to movement of the object or measuring other object movement,
wherein the motion sensor directly measures the altitude, measures an atmospheric pressure, or measures movement of the object using an angle, a velocity, the acceleration, the angular velocity, and the like.

5. The autonomous driving device of claim 1, wherein the guide information for the feedback information is received from an external server using the visual information based on augmented reality or virtual reality and updated.

6. An operating method of an autonomous driving device for providing visualized virtual guide information, the operating method comprising:
receiving a voice and image (motion) of an object;
analyzing feature values of the voice and image (motion) of the object;
defining a meaning of the feature value of the voice and the feature value of the image (motion) and then determining feedback information corresponding to the defined meaning; and
outputting guide information for the determined feedback information using visual information based on augmented reality or virtual reality.
